(19) United States
(12) Patent Application Publication
(10) Pub. No.: US 2026/0022645 A1
(43) Pub. Date: Jan. 22, 2026

(54) TURBINE GENERATOR ASSEMBLY

(71) Applicant: MITIS, Hannut (BE)

(72) Inventors: Michel Delanaye, Hannut (BE); Jean-Michel Teney, Liège (BE); Marine Hubert, Hannut (BE); Michel Delvaux, Hannut (BE)

(73) Assignee: MITIS, Hannut (BE)

(21) Appl. No.: 19/111,995

(22) PCT Filed: Oct. 20, 2023
(86) PCT No.: PCT/EP2023/079373

§ 371 Date: Mar. 14, 2025

(30) Foreign Application Priority Data
Oct. 21, 2022 (BE) BE2022/5849

(51) Int. Cl. F01D 15/10; F01D 15/08; F01D 25/16; H02K 7/08; H02K 7/18; H02K 11/225

(52) U.S. Cl. CPC F01D 15/10; F01D 15/08; F01D 25/16; H02K 7/08; H02K 7/1823; H02K 11/225; F05D 2220/76

(57) ABSTRACT

A turbine generator assembly for a power generation or cogeneration device. The assembly includes a turbine, a compressor and a motor-generator mechanically coupled by a central element. The assembly further includes an angular position detector of the central element in the form of a target attached to the end of the central element and an inductive sensor stationary relative to a stator of the motor-generator arranged to cooperate with the target.

### TECHNICAL FIELD

The present invention relates to an assembly which forms part of a turbine generator and is intended for use in a power generation unit or energy cogeneration unit.

### PRIOR ART

Known power generation unit or energy cogeneration unit include a combustion device feeding combustion gases to a turbine mechanically coupled to a compressor that compresses the air injected into the combustion device. Such a apparatus is described, for example, in the document WO2022089822A1.

The mechanical coupling between the turbine and the compressor is via a central element, supported in rotation by radial bearings. The documents U.S. Pat. No. 6,305,169 B1, US 2003/223892 A1 and DE 20 2006 004 975 U1 disclose such mechanical couplings. The correct positioning of these bearings is essential to achieve excellent stability, particularly at high rotation speed.

In this context, a motor-generator can be mechanically coupled to the turbine and compressor via the central element. In this case, sufficient air circulation must be provided between the rotor and the stator of the motor- generator, in particular for cooling purposes. In addition, a rotor of limited length is preferable to ensure rotor stability.

These technical constraints discourage, or at least complicate, the integration of means contributing to the control and/or monitoring of the device during operation.

### DISCLOSURE OF THE INVENTION

The object of the invention is to provide a turbine generator assembly for a power generation unit or an energy cogeneration unit comprising such means, taking into account the above-mentioned technical constraints.

To this end, the invention proposes a turbine generator assembly comprising:
a turbine configured to be supplied with combustion gases by a combustion device;
a compressor mechanically coupled to the turbine by a central element; and. a motor-generator axially offset from the compressor and mechanically coupled to the turbine and compressor by the central element; comprising an angular position detector for the central element, comprising:
a target attached to one end of the central element, and
an inductive sensor stationary relative to a stator of the motor-generator.

The detector enables the angular position of the central element to be determined simply, taking into account the technical constraints of the assembly, so that this data can be used to control and/or monitor the assembly during operation, for example, by controlling the rotation of the rotor part of the assembly in a closed loop. In this way, control is possible, thus preventing the assembly from stalling.

The use of a target attached to the end of the central element and an inductive sensor associated with the target is advantageous. The target can cover the end of the central element, on the one hand, without obstructing air circulation in the assembly, and, on the other hand, without requiring substantial axial extension of the rotor part of the assembly, and therefore with limited overall dimensions. In addition, the inductive sensor, by being fixedly arranged in relation to and/or at the level of and/or on the stator, can be positioned in the immediate vicinity of the target, taking advantage of the rotation of the central element (and therefore of the target) to generate the currents useful for detecting the angular position of the central element.

These advantages are further enhanced in the case of a motor- generator with a rotor attached to the central element and fitted with a rotor magnet device arranged in or around the central element from its end. In this case, to limit the length of the rotor, the rotor magnet device is arranged in the stator, which typically surrounds the rotor magnet device. As the target is simply attached to the end of the central element, it is preferably also arranged on the stator, like the inductive sensor. An additional axial space or axial extension of the rotor and/or central element is therefore not required for the detector, as the detector is located in the stator, as illustrated in FIGS. 4 and 6 below.

Limiting the length of the rotor and/or central element is beneficial for the stability and dynamism of the assembly, particularly in the case of a rigid central element with a radially measured diameter of between 15 and 40 mm subject to a high first natural frequency.

The detector of the assembly according to the invention also enables the angular position of the central element to be determined independently of the electromagnetic noise and temperature it is likely to experience within a turbine generator.

The rotor part of the assembly is preferably designed to rotate at a speed of at least 80,000 rpm, more preferably at least 100,000 rpm. For example, it can be designed to rotate at a speed of between 90,000 and 150,000 rpm.

As is known to a person skilled in the art, the “motor-generator” functions as a motor when it is supplied with electrical energy and provides energy in the form of motion, and as a generator when it is supplied with energy in the form of movement and provides electrical energy. Alternatively, the term “motor-generator” may be replaced in this document by “motor and/or generator”. The motor-generator is an electric motor-generator comprising a rotor and a stator.

The rotor of the motor-generator is typically formed by a part of the central element to which a rotor magnet device is attached. The rotor magnet device comprises one or more magnets which are preferably permanent.

The angular position detector can preferably also determine the rotation speed of the central element.

The target is preferably arranged in (and/or along) a radial plane at the end of the central element. The inductive sensor is preferably aligned axially (i.e. “on the axis” of main extension of the assembly, in particular of the central element) on the target, facing it, or in other words, opposite it. This arrangement is advantageously simple to install in a very small space, right at the stator of the generator motor.

The inductive sensor then also extends in a radial plane parallel to the plane in which the target extends, with the target and inductive sensor facing each other at a short distance, enabling the angular position of the central element (and therefore, where applicable, of the motor-generator rotor) to be determined without noise. The distance between the target and the inductive sensor is preferably between 0.5 and 2.0 mm, more preferably between 1.0 and 1.5 mm, for example, approximately (i.e., to within 10%) 1.0 mm. A distance greater than 2.0 mm makes angular position determination uncertain in this technical environment, while a sufficient safety distance of at least 0.5 mm must be ensured between the target and the inductive sensor.

According to a preferred embodiment of the invention, the inductive sensor is connected to an electronic device axially aligned with the inductive sensor and comprising a card for acquiring angular positions (and/or, where appropriate, rotational speeds) of the central element. The electronic device preferably extends axially from the inductive sensor, without projecting radially from the latter.

Since the electronic device is axially aligned with the inductive sensor, it fits into the axial extension of the inductive sensor and does not obstruct the air flow between the stator and rotor of the motor-generator. This is an advantage over similar electronic devices in the prior art, which are arranged in the same plane as the inductive sensor. Preferably, the electronic device, or at least the acquisition card, extends in a plane (carried axially and) perpendicular to the radial plane in which the inductive sensor extends, as illustrated in FIG. 7 below introduced.

The electronic device acquires and, preferably, processes and/or evaluates the angular position data (and/or rotational speed data, if applicable) from the detector. Preferably, it comprises or is connected to a processor or similar means for performing such processing and/or evaluation, for the purpose of monitoring and/or controlling (e.g., in a closed loop) the rotational operation of the assembly, thereby preventing possible stalling of the assembly according to the invention.

The electronic device is preferably supported by an ogive-shaped casing axially extending the inductive sensor. In this case, the casing is preferably also stationary relative to the motor-generator stator. The casing provides fixed support for the entire electronic device and the inductive sensor. Its ogive shape (in particular, as shown in FIGS. 4 and 6 below) plays an advantageous aerodynamic role, contributing to air circulation between the rotor and the stator of the motor-generator without obstructing it.

Preferably, the casing comprises internal notches for placing and holding the electronic device and the inductive sensor, typically in two perpendicular planes as described above.

In brief, according to several embodiments, the inductive sensor is connected to an electronic device supported by an ogive-shaped casing.

According to a preferred embodiment of the target, the target comprises, and more preferably consists of, an insulating surface and a metallic radial element. By its very nature, the metallic radial element becomes a reference point for the inductive sensor, in particular for determining the angular position of the central element. This embodiment is particularly simple and inexpensive to install in a limited space.

An easy and effective target design is to partially coat the insulating surface with the metal radial element, for example by fixing it to the surface, e.g. by gluing or screwing it on. In this way, the radial metal element is arranged axially between the inductive sensor and the insulating surface. It is seen directly by the inductive sensor, which can easily distinguish the radial metal element from the rest of the insulating surface during rotation.

For example, the insulating surface may have an axial thickness of 2.0 to 3.0 mm, e.g. 2.4 mm, while the metallic radial element is very thin axially, e.g. with an axial thickness of only a few um, e.g. between 20 and 60 μm, e.g. 35 μm.

The metallic radial element preferably consists of copper (Cu). The insulating surface is made, for example, of printed circuit board (PCB), preferably a glass-fiber-reinforced epoxy resin composite material (known as FR-4). Advantageously, this same substrate can be used for the design of the inductive sensor and/or the electronic device if required. It has the advantage of low weight and good resistance to centrifugal force, which is particularly relevant in the case of the target.

The insulating surface (and preferably the target as a whole) and the inductive sensor preferably extend along two parallel disks. The insulating surface is preferably ring-shaped, while the inductive sensor is preferably disk-shaped with the same external radius.

In other words, the target and the inductive sensor each preferably have a circular edge of the same radius.

This geometry is designed to best suit the assembly, for example because the target is attached to the end of the central element (and rotor), which typically has a disk-shaped end of the same radius. In this way, the target and inductive sensor are completely integrated into the assembly (without protruding radially), preferably at the level of the motor-generator stator, in very little space and without obstructing the air flow between the motor-generator stator and rotor.

The insulating surface can include a visual mark, such as a dot or radial line mark, useful for testing the assembly at low rotational speed.

The metallic radial element can take various radial shapes depending on the constraints of the assembly, for example the number of poles of a rotor magnet device as mentioned above. Preferably, it is a metallic surface which partially coats the insulating surface. This design is preferred because it is easy to detect and simple to design. For example, the metallic radial element is a one-piece surface and takes the shape of a half-circle or half-moon, and/or covers approximately (to within 10%) half of the insulating surface. This design is particularly suitable for detection when the rotor magnet device is bipolar. The skilled person will understand that other embodiments, for example with two metal surface portions covering two opposite quarters of the insulating surface, or another number of such portions, are possible.

Preferably, the target comprises an axial hole. This is particularly the case when the insulating surface is ring-shaped as described above. The axial hole makes it possible to include target fastening elements at the end of the central element. Preferably, the hole is chamfered. In particular, the hole has a flared shape on the face of the target opposite the end of the central element. This design is advantageous because it enables the target to be attached by a screw, for example of suitable geometry, without the screw head protruding axially beyond the target. In this way, the inductive sensor can be arranged as close as possible to the target, as described above, without having to provide an additional distance for the screw head (or any other fastening element).

In particular, a fastener, for example a screw, is then preferably arranged in the chamfered axial hole to attach the target to the end of the central element.

As an alternative to the above, a partially machined metal extension of the central element (and/or of the motor-generator rotor) may be used as the target. In this way, the difference in axial length of the central element (and/or rotor) between its machined part and its non-machined part can be detected by the inductive sensor to deduce the angular position of the central element (and/or rotor).

In particular, preferably, a fastener, for example a screw, is then arranged in the chamfered axial hole to attach the target to the end of the central element.

According to an embodiment of the target visible in FIG. 8 hereinafter introduced, the target extends into a ring comprising a plurality of axial orifices. These are preferably oriented away from the central element. The inductive sensor preferably faces the target without extending parallel to the ring, so that it does not contribute to determining the angular position of the central element.

The orifices can then be advantageously used to balance the assembly in situ of the assembly, for example by inserting a soldering point in one or more of the orifices.

As mentioned in the prior art, the assembly is preferably provided with one or more radial bearings designed to guide the central element in rotation. According to one embodiment within the scope of the present invention, the bearings comprise:
a first radial bearing located axially between the turbine and the compressor, and
a second radial bearing located axially between the compressor and the motor-generator.

The radial bearings are then located axially on either side of the compressor: the first bearing is located between the turbine and the compressor, and the second bearing is located between the compressor and the motor-generator. Such a distribution of radial bearings allows us to take up the moments of force in a particularly effective way because these moments come from the masses of the turbine, the compressor and the rotor of the motor-generator (the latter being particularly heavy). It therefore allows the number of radial bearings to be limited.

In addition, the position of the second bearing, on the other side of the compressor from the turbine, reduces the distance between the turbine and the compressor, provides better ventilation of the region between the turbine and the compressor, which is very hot, and therefore improves system stability.

For the purpose of this document, a “radial” bearing is a bearing preventing movement perpendicular to the axis of rotation, and an “axial” bearing is a bearing preventing movement parallel to the axis of rotation. The terms “radial” and “axial” refer more generally to directions perpendicular and parallel to the axis of rotation respectively. The assembly, and in particular the central element and/or rotor, preferably extends along this axis and rotates around it. The radial bearings can be separated radially from the central element by another rotating element attached to the central element.

For the purposes of this document, a radial bearing is an aerodynamic bearing. Thus, during rotation, the central element levitates, separated from the bearing by a layer of air that supports the bearing by a lift effect. This is not a rolling bearing. It does not require lubrication.

In one embodiment, the first radial bearing and the second radial bearing are foil bearings. Foil bearings make it possible to use a central element with a larger diameter than would be possible with other bearings, such as ball bearings. This makes it possible to increase the first natural bending frequency, which improves stability and high-speed operation.

In one embodiment, the assembly comprises an air pipe leading to the compressor, the air pipe being located between the compressor and the second radial bearing and having a radial component.

Instead of an axial air pipe located between the rotor and the stator, it is preferred that the air pipe is between the second radial bearing and the compressor and is not parallel to the axis (in other words, it has a radial component). This allows the distance between the rotor and stator to be particularly small, which improves the electro-magnetic-mechanical stability of the system and reduces reactive power, while also improving the angular phase shift (cosine φ). The air pipe may comprise one or more bends, comprise a radial section and/or comprise an inlet scroll that takes in air from the side, and spirals it at a specific angle.

According to one embodiment, the central element is made of a single piece or of a plurality of pieces attached together so as to rotate integrally.

The central element, which extends from the turbine through the compressor to the motor-generator, therefore has a rotational speed that is identical over its entire length. A central element made of one piece or made of integrally attached parts simplifies the balancing procedure, which is particularly delicate in a turbine generator assembly such as that of the invention.

In one embodiment, the first radial bearing is the only radial bearing between the turbine and the compressor. There is therefore no radial bearing other than the first radial bearing between the turbine and the compressor. This reduces the distance between turbine and compressor, thus improving system stability.

In one embodiment, the first radial bearing and the second radial bearing are the only radial bearings. There is therefore no other radial bearing, either beyond the motor-generator to the compressor, or between the motor- generator and the turbine, or beyond the turbine to the compressor. As the turbine generator assembly described here rotates particularly quickly, the issue of concentricity is an important one. The smaller the number of bearings, the easier it is for them all to be concentric. Having two bearings is an interesting compromise between the constraints of stability and concentricity.

In one embodiment, the turbine generator assembly comprises an abutment and an axial bearing configured to prevent axial movement of the abutment. The abutment, which may be referred to as an axial abutment, is preferably located between the turbine and the compressor. It is attached directly or indirectly to the central element.

According to one embodiment, the turbine generator assembly comprises a shaft releasably attached to the central element such that the shaft and central element rotate together, with the stop forming part of the shaft. The shaft could also be called a “rotating element”. The presence of the shaft, forming a separate part from the central element, allows the radial bearings, the compressor and the turbine to be threaded onto the central element.

According to one embodiment, the motor-generator comprises a rotor attached to the central element and comprising a bipole rotor magnet device, preferably with permanent magnet(s). In other words, the rotor magnet device comprises only one south pole and one north pole. Given the very high rotation speed, the assembly is easier to straighten than with a quadrupole or with more magnetic poles. This can be a single permanent magnet.

According to one embodiment, the motor-generator comprises a rotor attached to the central element and comprising a rotor magnet device located inside the central element. This allows the rotor magnet device, which is particularly heavy, to be close to the axis. It is possible, however, while remaining within the scope of the invention, for the rotor magnet device to be attached outside the central element, for example shrunk onto the central element.

According to one embodiment, the central element comprises a cavity having an opening in a radial plane and located at one end of the central element, the rotor magnet device being located in the cavity. The opening allows the rotor magnet device to be inserted into the central element, centering it with particular precision.

In one embodiment, the central element has a diameter greater than 15 mm and less than 40 mm. This diameter is naturally measured radially. The diameter of the central element can vary depending on the position along the axis, but preferably nowhere is it less than 15 mm or greater than 40 mm. A small diameter allows the value of the first bending natural frequency, which in turn reduces stability and high-speed operation. A larger diameter reduces the efficiency of the turbine generator assembly. The above-mentioned range allows a compromise between these two constraints.

The invention also provides a power generation or an energy cogeneration unit comprising a turbine generator assembly according to the invention. Preferably, the only radial bearings are the first radial bearing and the second radial bearing.

### BRIEF DESCRIPTION OF THE FIGURES

Further characteristics and advantages of the invention will become apparent from the following detailed description, for the understanding of which reference is made to the appended figures, among which:

FIG. 1 is a schematic diagram of a power generation unit or energy cogeneration unit;

FIG. 2 is an axial section of part of a turbine generator assembly,

FIG. 3 is an axial section of a part of another turbine generator assembly,

FIG. 4 is an axial section of the turbine generator assembly partly illustrated in FIG. 2,

FIG. 5 is a front view of a target,

FIG. 6 is a partial axial cross-section of the turbine generator assembly partially illustrated in FIG. 2, reproducing part of FIG. 4 in greater detail,

FIG. 7 is a three-dimensional view of an inductive sensor connected to an electronic device,

FIG. 8 is a front view of a different target from FIG. 5.

### EMBODIMENTS OF THE INVENTION

The present invention is described with particular embodiments and references to figures, but the invention is not limited thereby. The drawings or figures described are schematic only and are not limiting. Furthermore, the functions described may be carried out by structures other than those described in this document.

In the figures, identical or similar elements may have the same references. Reference numbers in the claims do not limit their scope.

In this document, the terms “first” and “second” are used to differentiate between the various elements and do not imply any order between these elements. In this document, the use of the verbs “include”, “comprise”, or any other variant, as well as their conjugations, cannot exclude the presence of elements other than those mentioned. Similarly, in this document, the use of an indefinite article “a”, “an”, and/or a definite article “the”, to introduce an element does not exclude the presence of a plurality of these elements.

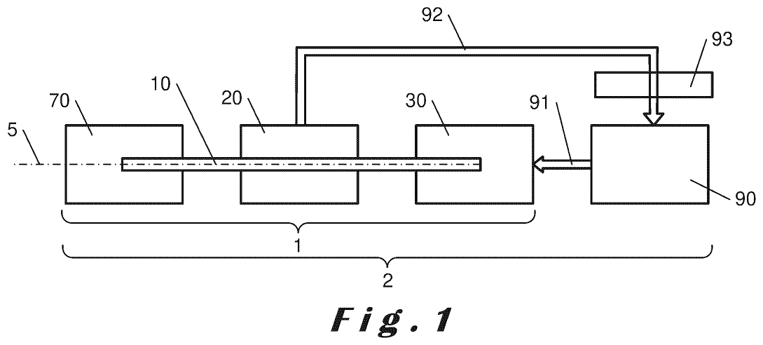

FIG. 1 schematically illustrates various elements of a power generation unit or an energy cogeneration unit 2. The device 2 comprises a combustion device 90, a turbine 30, a compressor 20 and a motor-generator 70. Combustion device 90 transmits combustion gases (i.e. resulting from combustion) to the turbine 30 via a first pipe 91. The turbine 30, the compressor 20 and the motor-generator 70 are mechanically coupled via a central element 10. The air compressed by the compressor 20 is sent to the combustion device 90 via a second pipe 92 and a recuperator 93 which preheats the compressed air before injecting it into the combustion device 90. The compressor 20 is preferably shrunk onto the central element 10.

For the purposes of this document, a turbine generator assembly 1 comprises the turbine 30, the compressor 20, the motor-generator 70 and the central element 10, which are aligned for rotation about the axis 5. It is connected to the combustion device 90. The turbine 30, the compressor 20, ant the motor-generator 70 are arranged axially in the following order: turbine 30, compressor 20, motor-generator 70, so as to be axially distant from each other.

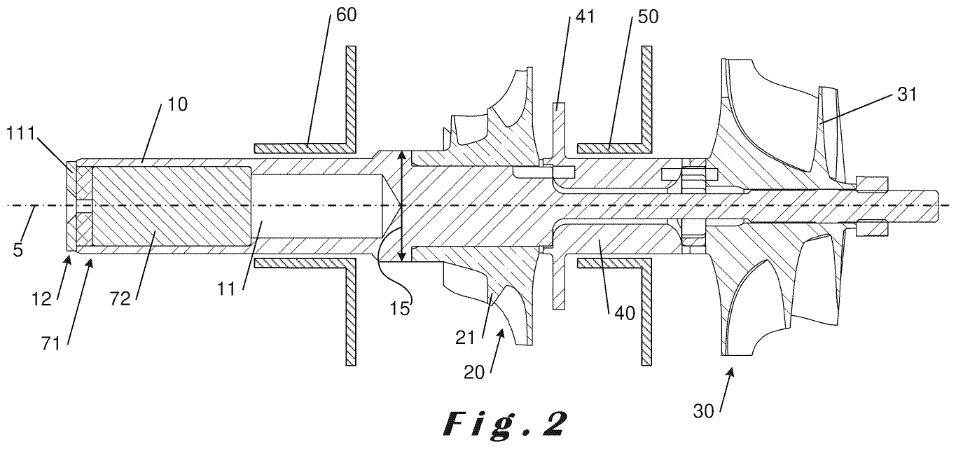

FIG. 2 illustrates parts of a turbine generator assembly 1. It shows in particular the blades 31 of the turbine 30, the blades 21 of the compressor 20, and a rotor magnet device 72 of the rotor 71 of the motor-generator 70.

In this embodiment, the turbine 30 and the compressor 20 are separated axially by a first radial bearing 50, which radially surrounds the central element 10. The first radial bearing 50 is preferably the only radial bearing between the turbine 30 and the compressor 20.

In this embodiment, the compressor 20 and the motor-generator 70 are also separated axially by a second radial bearing 60, which radially surrounds the central element 10. In particular, the second radial bearing 60 separates the compressor axially from the rotor magnet device 72. The second radial bearing 60 is preferably the only radial bearing between the compressor 20 and the motor-generator 70.

The first radial bearing 50 and the second radial bearing 60 are preferably foil bearings. The first radial bearing 50 and the second radial bearing 60 are preferably the only radial bearings in the turbine generator assembly 1 and the power generation unit or energy cogeneration unit 2.

Preferably, the central element 10 is made of a single piece or from a plurality of pieces attached together so that they all rotate at the same angular speed, as if they were one piece.

Preferably, the radial diameter 15 of the central element, whatever the position of along axis 5, is greater than 15 mm and/or less than 40 mm.

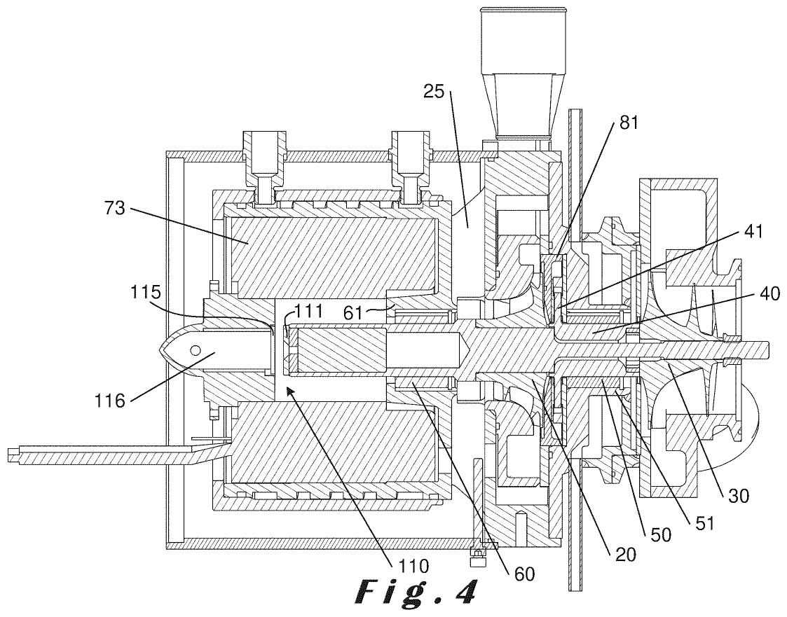

Preferably, the central element 10 is attached to a shaft 40 which surrounds it radially, and the first radial bearing 50 surrounds the shaft 40 radially. The shaft 40 is located axially between the turbine 30 and the compressor 20. The shaft 40 comprises an axial abutment 41 held by an axial bearing 81 (visible in FIG. 4). The abutment 41 is such that the diameter 15 of the central element 10, at any point, is smaller than the diameter of the abutment 41.

The rotor magnet device 72 is preferably a bipole, for example a magnet. In the embodiment shown in FIG. 2, it is located in a cavity 11 inside the central element 10. The cavity 11 preferably comprises an opening leading axially onto the end 12 of the central element 10.

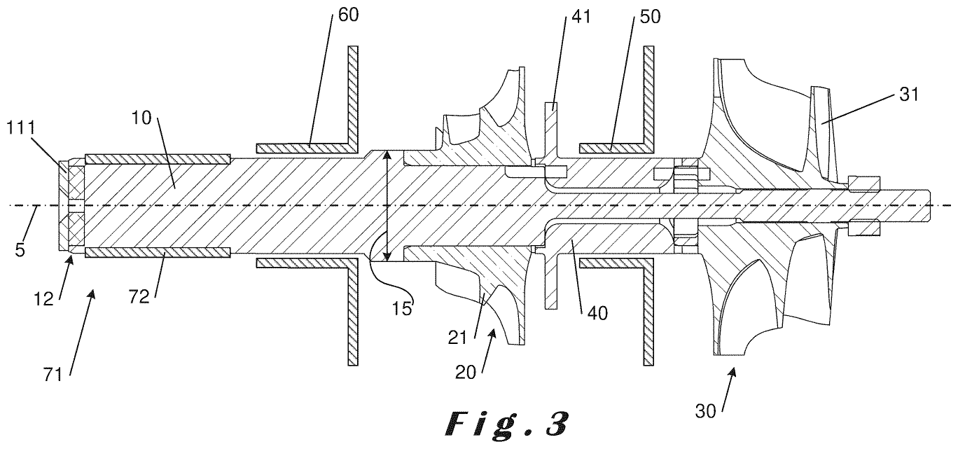

In the embodiment shown in FIG. 3, the rotor magnet device 72 is attached to the outside of the central element 10, so as to surround it radially.

FIGS. 2 and 3 further illustrate a target 111 attached to one end 12 of the central element 10, which is at the heart of the present invention as described in the disclosure of the invention. This same target is commented on below with reference to FIGS. 4, 5 and 6.

FIG. 4 illustrates parts of a turbine generator assembly 1. The turbine generator assembly 1 comprises an air pipe 25 supplying air to the compressor 20. The air pipe 25 is preferably located between the compressor 20 and the second radial bearing 60. It has a radial component, i.e. the air path in this air pipe 25 is not solely axial.

The turbine generator assembly 1 preferably comprises a first bearing support 51 around the first radial bearing 50 and a second bearing support 61 around the second radial bearing 60. The first 51 and second 61 bearing supports are stationary relative to each other and are concentric. The first 51 and second 61 bearing supports are stationary relative to a stator 73 of the motor-generator 70.

Within the scope of this invention, the turbine generator assembly 1 is provided with a detector 110 for determining the angular position of the central element 10 and preferably the angular velocity of the central element 10.

The detector 110 comprises a target 111 attached to the end 12 of the central element 10 in a radial plane. It rotates with the central element 10 while remaining in the same plane. The detector 110 also comprises an inductive sensor 115 axially aligned with the target 111, and stationary relative to the stator 73 of the motor-generator 70. As shown in FIG. 6, the detector is connected to an electronic device 118 comprising a speed and/or angular position acquisition card which is supported by an ogive-shaped casing 116. On the basis of angular position and/or angular velocity measurements from the detector 110, the electronic device 118 typically controls and/or monitors the turbine generator assembly 1, thus preventing it from stalling.

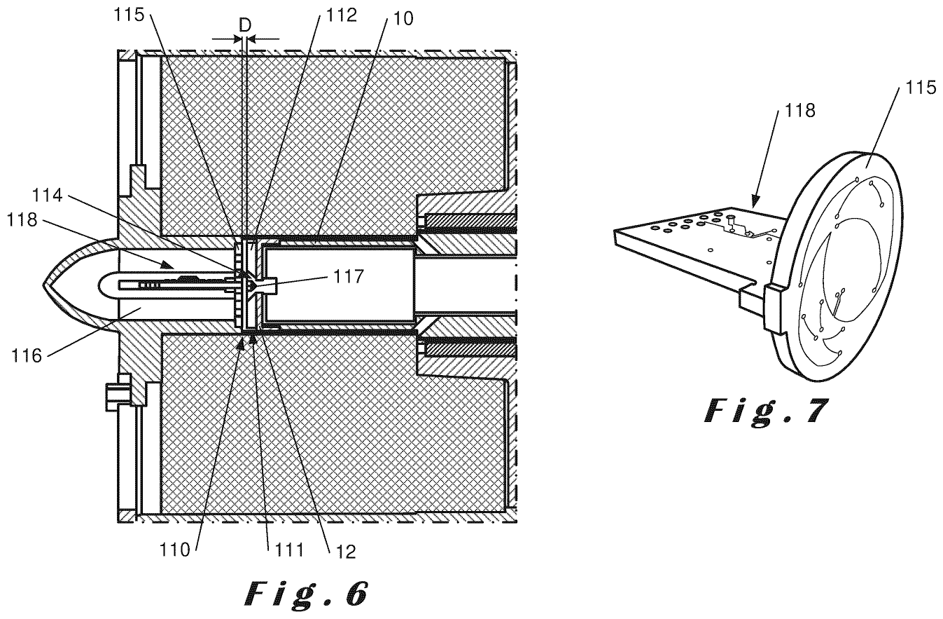

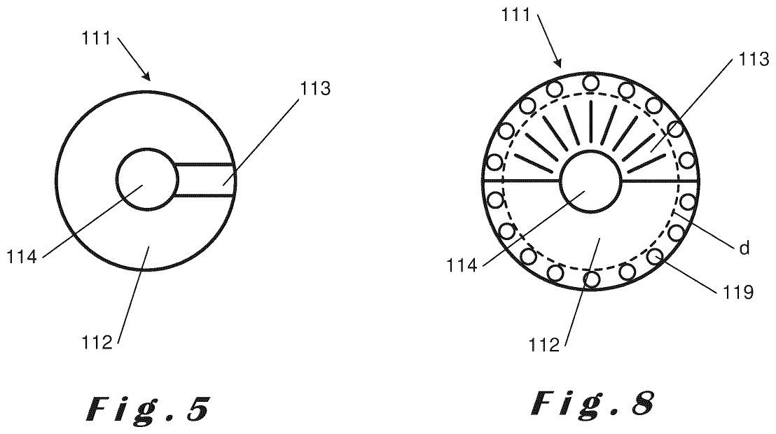

The target 111 and the inductive sensor 115 preferably have a similar geometry, as shown in FIGS. 5 to 8. They are inscribed in two disks of the same radius, extending along two parallel radial planes, so that they face each other at a distance D of approximately 1 mm. They both have a circular edge d of the same radius, corresponding approximately to the radius of a radial section at the end 12 of the central element 10. Target 111 is configured to cooperate electromagnetically with inductive sensor 115.

The inductive sensor 115 can be seen more precisely in FIG. 7, and is designed, for example, from a PCB body on which various metal coils, e.g. copper, and connection points are arranged. This type of device is well known to those skilled in the art. It comprises, for example, a transmitter coil and two receiver coils for the signal from the target. The electronic device 118, or at least the acquisition card, is formed by a printed circuit, for example on a material of the same PCB. It is connected to the inductive sensor 115 by a plurality of soldering points between the coils and the electronic circuit, so as to extend in a plane perpendicular to the radial plane in which the inductive sensor 115 extends, so as to be in its axial extension and not to project radially with respect to the inductive sensor 115.

FIG. 5 illustrates the target 111 in one embodiment of the invention. It consists of an insulating surface 112 and a radial metal element 113. The latter is illustrated in the form of a radial metal surface attached in or on the insulating surface 112. The target 111 is pierced by a hole 114, preferably chamfered and axial as can be seen from the cross-section of FIGS. 2, 3, 4 and 6. This hole 114 allows the target 111 to be fastened to the central element 10 by means of a screw 117 with a countersunk head and/or adapted geometry, without the screw head protruding axially from the target 111, as illustrated in FIG. 6.

FIG. 8 illustrates another target 111 suitable for implementing the present invention. The metal radial element 113 is in the form of a half-moon, more precisely a half-ring covering approximately half of the insulating surface 112. In this embodiment, the target 111 extends into a ring comprising a plurality of axial orifices 119 usable for in situ balancing of the turbine generator assembly 1 by inserting weights, for example from molten metal deposits. The ring is arranged beyond edge d so that it does not contribute to or interfere with detection by the inductive sensor. The ring and the radial half- moon element are two independent features, although illustrated on the same figure.

The target 111 and the inductive sensor 115 can be designed from the same body (the insulating surface 112 for the target 111 and the copper coil support for the inductive sensor 115) of PCB materials as described in the disclosure of the invention.

Briefly, the invention relates to a turbine generator assembly 1 for an energy production or cogeneration device comprising a turbine 30, a compressor 20 and a motor-generator 70 mechanically coupled together by a central element 10. The assembly comprises an angular position detector 110 of the central element 10 in the form of a target 111 attached at the end 12 of the central element 10 and an inductive sensor 115 stationary relative to a stator 73 of the motor-generator 70 arranged to cooperate (electromagnetically) with the target 111.

The present invention has been described above in connection with specific embodiments, which are illustrative and should not be considered as limiting. It will be readily apparent to the person skilled in the art that the invention is not limited to the examples illustrated or described above, and that its scope is more broadly defined by the claims hereinafter introduced.

1. A turbine generator assembly, comprising:
a turbine configured to be supplied with combustion gases by a combustion device;
a compressor mechanically coupled to the turbine by a central element; and
a motor-generator axially offset from the compressor and mechanically coupled to the turbine and the compressor by the central element,
wherein the turbine generator assembly comprises an angular position detector for the central element, the angular position detector comprising:
a target attached to one end of the central element, and
an inductive sensor stationary relative to a stator of the motor-generator.

2. The turbine generator assembly according to claim 1, wherein:
the target is arranged in a radial plane at the end of the central element, and
the inductive sensor is axially aligned with, and faces, the target.

3. The turbine generator assembly according to claim 1, wherein a distance separating the target and the inductive sensor is between 0.5 and 2.0 mm.

4. The turbine generator assembly according to claim 1, wherein the inductive sensor is connected to an electronic device axially aligned with the inductive sensor and comprising an angular position acquisition card.

5. The turbine generator assembly according to claim 4, wherein the electronic device axially extends the inductive sensor, without projecting radially with respect to the inductive sensor.

6. The turbine generator assembly according to claim 4, wherein the electronic device is supported by an ogive-shaped casing axially extending the inductive sensor.

7. The turbine generator assembly according to claim 1, wherein the target includes an insulating surface and a metallic radial element.

8. The turbine generator assembly according to claim 7, wherein the metallic radial element partially covers the insulating surface so that it is arranged axially between the inductive sensor and the insulating surface.

9. The turbine generator assembly according to claim 1, wherein the target comprises a chamfered axial hole.

10. Turbine generator assembly according to claim 1, wherein the target and the inductive sensor each have a circular edge of the same radius.

11. The turbine generator assembly according to any of the preceding claim 1, wherein the target extends into a ring comprising a plurality of axial orifices.

12. The turbine generator assembly according to claim 1, wherein the motor-generator comprises a rotor attached to the central element, and comprising a bipolar rotor magnet device.

13. The turbine generator assembly according to claim 1, wherein the motor-generator comprises a rotor attached to the central element, and comprising a rotor magnet device located inside the central element.

14. The turbine generator assembly according to claim 13, wherein the central element comprises a cavity having an opening in a radial plane and located at the end of the central element, the rotor magnet device being located in the cavity.

15. The turbine generator assembly according to claim 1, further comprising:
a first radial bearing located axially between the turbine and the compressor and designed to guide the central element in rotation; and
a second radial bearing, located axially between the compressor and the motor-generator, and designed to guide the central element in rotation.

16. The turbine generator assembly according to claim 15, wherein the first and second radial bearings are the only radial bearings of the turbine generator assembly.

17. The turbine generator assembly according to claim 15, further comprising an air pipe leading to the compressor, the air pipe being located between the compressor and the second radial bearing and having a radial component.

18. The turbine generator assembly according to claim 1, wherein the central element is made of a single piece or of a plurality of pieces attached together so as to rotate integrally.

19. The turbine generator assembly according to claim 1, wherein the central element has a diameter greater than 15 mm and less than 40 mm.

20. A power generation or energy cogeneration unit comprising a turbine generator assembly according to claim 1.
